(19) United States
(12) Patent Application Publication
(10) Pub. No.: US 2025/0387751 A1
(43) Pub. Date: Dec. 25, 2025

(54) IONIC ELECTRIC FIELD (IEF) FILTRATION FOR LASER AND THREE-DIMENSIONAL (3D) PRINTING FUME AND DUST EXTRACTION

(71) Applicant: MURPHY ENTERPRISES OF ALBAMA INC., Hoover, AL (US)

(72) Inventor: Rexford E. Murphy, Hoover, AL (US)

(21) Appl. No.: 19/243,941

(22) Filed: Jun. 20, 2025

Related U.S. Application Data
(60) Provisional application No. 63/661,814, filed on Jun. 19, 2024.

(51) Int. Cl. B01D 53/32; B33Y 40/00

(52) U.S. Cl. CPC B01D 53/323; B01D 2201/08; B33Y 40/00

(57) ABSTRACT

A filtration system for laser and three-dimensional (3D) printing fume and dust extraction includes a prefilter, a charging grid, and an electrostatic collection module. An inline filter box incorporating the filtration system is positioned between a laser or 3D printer and a main pollutant extraction system. The prefilter draws polluted air to remove large particles. The remaining smaller particles are made to go through the charging grid. At the charging grid, an electric field charges the particles and begins breakdown of chemical pollutant structure. Subsequently, the charged particles are made to pass into the electrostatic collection module. The charged particles are made to get attracted to the electrostatic surfaces of the electrostatic collection module resulting in very high removal of particles (over 95%), and destruction of germs and chemical pollutants.

### CROSS-REFERENCE TO RELATED APPLICATIONS

The present application claims the benefit of U.S. Provisional Application No. 63/661,814, filed Jun. 19, 2024; all of which is incorporated herein in its entirety and referenced thereto.

### BACKGROUND OF THE INVENTION

### Field of the Invention

The present invention relates to filtration systems, and in particular, relates to a filtration system for laser and three-dimensional (3D) printing fume and dust extraction.

### Description of the Prior Art

It is known that laser engraving, cutting, and similar processes generate particles and chemical pollutants. Exemplary applications include, but not limited to, laser and three-dimensional (3D) printing fume and dust extraction. It is important to efficiently remove the particles and chemical pollutants to maintain a safe working environment. Typically, the particle and chemical pollutants are removed by connected filtration units with high-efficiency particulate air (HEPA) and activated carbon filters. The particle and chemical pollutants are filtered using prefilters before they are sent to the extractor's particle filters. Generally, an inline filter box is used to pre-filter the particles, and for extending the life of the extractor's particle filters. FIG. 1 shows an exemplary filtration unit 10, in accordance with prior art. Filtration unit 10 includes an inline filter box 12 and an extractor 14. Inline filter box 12 encompasses a bag filter 16. FIG. 2 shows a top view of bag filter 16, in accordance with prior art. Bag filter 16 removes a good percentage of the particles, say up to 40% of the larger particles before they are sent to the extractor's particle filters. Since a large portion of the larger particles have to be filtered by the extractor's particle filters, their life gets shortened or their performance reduces with time thereby polluting the surroundings.

Several other techniques have also been disclosed in the past to remove the particle and chemical pollutants during laser and three-dimensional (3D) printing fume and dust extraction. One such example is disclosed in a Chinese Publication No. 207187411U, entitled “An air purifier for laser fabric cutting machine” (“the '411 Publication”). The '411 Publication discloses an air purifier for laser fabric cutting machine, including casing, air intake and air outlet, the bilateral symmetry of casing sets up air intake and air outlet, and air intake intercommunication inertia dust collection compartment, installs early effect filters, high pressure plasma electric field, medium efficiency filter, high efficiency filter, modified active carbon and ozone catalysis board between inertia dust collection compartment and the air outlet in proper order, the utility model discloses an air purifier can utilize principle of inertia through setting up inertia dust collection compartment in air intake department, the bottom of the cavity that a large amount of dust fibers of producing laser fabric cutting machine were collected, afterwards, make remaining dust fiber loop through early effect filters, the high pressure plasma electric field, the medium efficiency filter, high efficiency filter, modified active carbon and the ozone catalysis board filtration purification that removes dust, the life of improvement filter that can be at double, avoid causing filter clogging, material cost is low, simple device structure, be favorable to improving air purifier's economic benefits.

Another example is disclosed in a Japanese Patent No. 6600211, entitled “ELECTRIC DUST COLLECTOR” (“the '211 Patent”). The '211 Patent discloses an electric dust collector collecting dust such as fume and the like generated from a processor includes: an electric charge part charging the dust by applying high voltage; a dust collection part collecting the dust charged in the electric charge part; a fan forcibly blowing out a dust-containing gas to the electric charge part and the dust collection part; and a dust removing member removing the dust collected in the dust collection part. The fan is stopped when a dust removal permission signal output from the processor during the operation of the processor is received and the dust collected in the dust collection part is removed by the dust removing member after stopping the application of high voltage to the electric charge part.

Although the above discussed disclosures are useful, they have few problems. For example, the efficiency of the bag filters is not sufficient to remove a large percentage of the particle and chemical pollutants. Further, none of them utilize a two-pole active (TPA) technology for use with a pre-filter unit that goes in between a laser or 3D printer, and a main pollutant extraction system for laser and 3D fume/dust extraction. Further, the traditional bag filters and filters within the extractor are very expensive and increase the overall filtration costs.

Therefore, there is a need in the art to provide a unique filtration system for laser and three-dimensional (3D) printing fume and dust extraction.

### SUMMARY OF THE INVENTION

It is an object of the present invention to provide a filtration system for laser and three-dimensional (3D) printing fume and dust extraction.

It is another object of the present invention to provide a filtration system having an ionic electric field (IEF) filter that can be used in place of a traditional bag filter.

It is another object of the present invention to provide a filtration system utilizing a two-pole active (TPA) technology for offering an active filtration by generating a high voltage electric field to electrify and destroy harmful particles, attracting them to washable collecting plates (electrostatic collection modules).

In order to achieve one or more objects, the present subject matter provides a filtration system for laser and three-dimensional (3D) printing fume and dust extraction. The filtration system includes a prefilter, a charging grid, and an electrostatic collection module. An inline filter box incorporating the filtration system is positioned between a laser or 3D printer and a main pollutant extraction system. The prefilter draws polluted air to remove large particles. The remaining smaller particles are made to go through the charging grid. At the charging grid, an electric field charges the particles and begins breakdown of chemical pollutant structure. Subsequently, the charged particles are made to pass into the electrostatic collection module. The charged particles are made to get attracted to the electrostatic surfaces of the electrostatic collection module resulting in very high removal of particles (over 95%), and destruction of germs and chemical pollutants.

In one advantageous feature of the present subject matter, the prefilter and the electrostatic collection module are cleanable, allowing them to be reusable.

In another advantageous feature of the present subject matter, the electrostatic collection module removes even the tiniest particles, and eliminates the need for traditional bag filter in common inline filter boxes.

These and other objects of the present invention will be apparent from review of the following specification and the accompanying drawings.

### BRIEF DESCRIPTION OF THE DRAWINGS

FIG. 1 is a schematic view of a filtration unit having an inline filter box and an extractor, in accordance with prior art.

FIG. 2 is a top view of a bag filter that positions in the inline filter box, in accordance with prior art.

FIG. 3 is a perspective view of a filtration system, in accordance with one embodiment of the present subject matter.

FIG. 4 is an exploded view of an ionic electric field (IEF) module, in accordance with one embodiment of the present subject matter.

FIG. 5 is a method of filtration for laser and three-dimensional (3D) printing fume and dust extraction, in accordance with one embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed filtration system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed filtration system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a filtration system, it is to be further understood that numerous changes may arise in the details of the embodiments of the filtration system. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

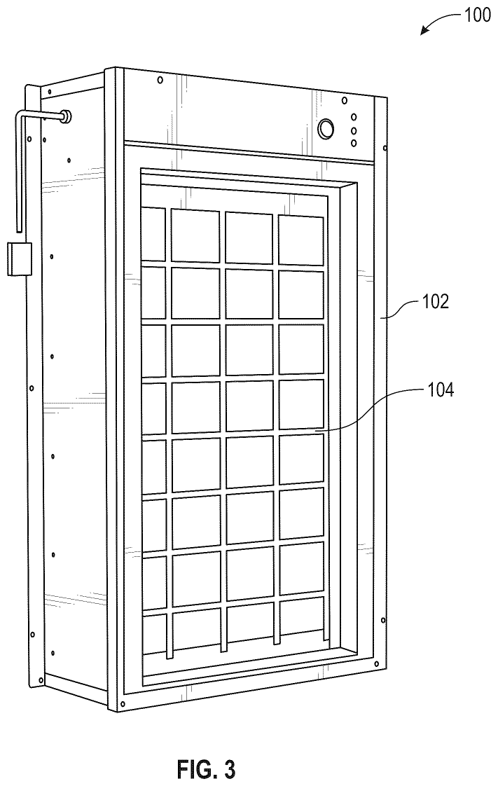

Various features and embodiments of a filtration system are explained in conjunction with the description of FIGS. 3-5.

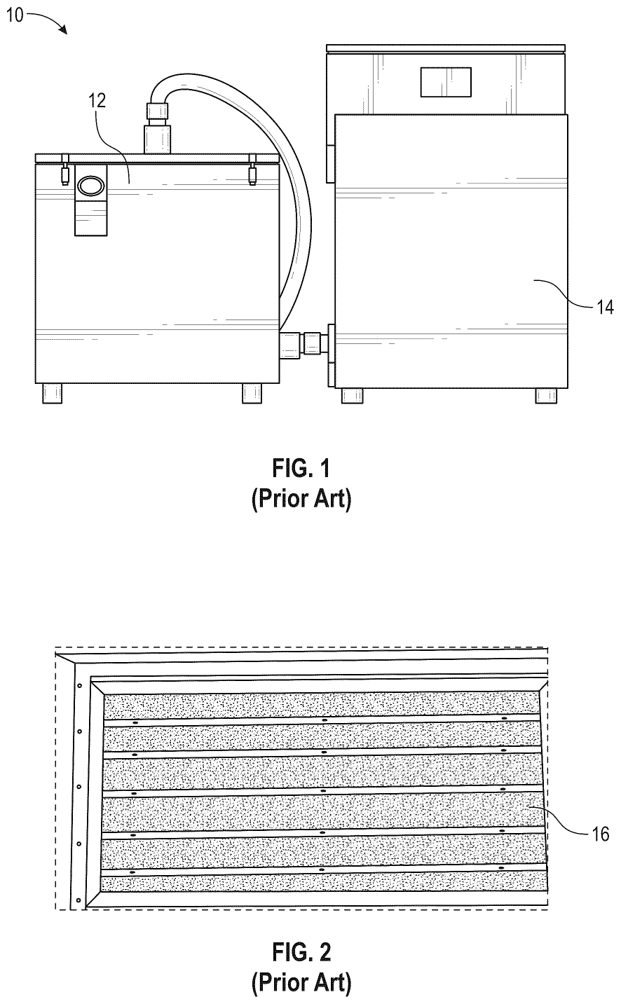

FIG. 3 shows a perspective view of a filtration system 100, in accordance with one embodiment of the present subject matter. Filtration system 100 includes an enclosure 102. Enclosure 102 comes in a rectangular, square or any other configuration. Enclosure 102 is made of a metal, plastic or any other suitable material. In accordance with one embodiment, enclosure 102 encompasses an ionic electric field (IEF) module 104. IEF module 104 is configured to sit within an inline filter box (not shown, similar to an inline filter box 12, as shown in FIG. 1 of prior art). In accordance with the present subject matter, IEF module 104 is used by replacing a bag filter (not shown, similar to a bag filter 16, as shown in FIG. 2 of prior art) in the inline filter box for removing particle and chemical pollutants during laser and three-dimensional (3D) printing fume and dust extraction.

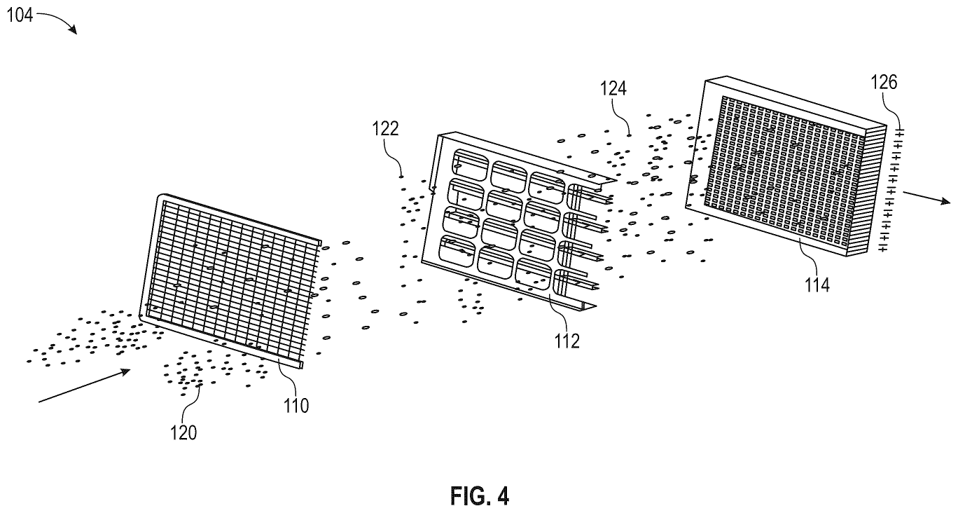

FIG. 4 shows an exploded view of IEF module 104, in accordance with one embodiment of the present subject matter. IEF module 104 includes a prefilter 110, a charging grid 112, and an electrostatic collection module 114. As can be seen, charging grid 112 positions between prefilter 110 and electrostatic collection module 114. Here, prefilter 110 acts as a primary filter and draws polluted air. Electrostatic collection module 114 acts as an electric filter or micro-electrostatic dust collection module and allows the cleaned air to exit from IEF module 104. Prefilter 110 and electrostatic collection module 114 are cleanable/washable. As such, they can be reused multiple times without degradation in its filtration performance.

Still referring to FIG. 4, the working principle of IEF module 104 is explained. At first, the inline filter box incorporating IEF module 104 is positioned between a laser or 3D printer and a main pollutant extraction system. As specified above, prefilter 110 acts as a primary filter. As such, during the operation, polluted air 120 generated by the laser or 3D printer is made to pass through prefilter 110. Prefilter 110 removes large particles and allows smaller particles 122 to go towards charging grid 112. Charging grid 112 is negative (−ve) charged with high voltage. As such, the smaller particles 122 pass-through charging grid 112, and an electric field charges the particles (charged particles 124). Charged particles 124 begin to break down of chemical pollutant structure. Subsequently, charged particles 124 pass into electrostatic collection module 114. Charged particles 124 get attracted to electrostatic surfaces of electrostatic collection module 114 resulting in very high removal of particles. Clean air 126 exits from electrostatic collection module 114 and travels to an extractor (main extractor system). In one example, electrostatic collection module 114 removes over 95% of particles, and destructs germs and chemical pollutants. As the particles, chemical pollutants and the gems are removed, the clean air supplied to the extractor (not shown, similar to extractor 14 in FIG. 1 of prior art) helps to improve the life of a filter within the extractor.

In one embodiment, electrostatic collection module 114 utilizes a two-pole active (TPA) technology for offering an active filtration by generating a high voltage electric field to electrify and destroy harmful particles, attracting them to washable collecting plates. In other words, electrostatic collection module 114 offers a new generation air purification technology, which is a highly efficient air filtration solution with unique intense-field dielectric. The intense-field dielectric indicates a mechanism by which IEF module 104 is able to remove even the tiniest particles without the use of a high-pressure-drop fiber matrix. In addition, electrostatic collection module 114 generates a “coulomb force” generated by a high voltage (˜10K) electrostatic field that destroys molecular structure of airborne microorganisms.

Although the present description is explained considering IEF module 104 includes three stage filters i.e., prefilter 110, charging grid 112, and electrostatic collection module 114, it is possible to provide one or more prefilters and after filters depending on an application of use for particle removing and/or chemical removing without departing from the scope of the present subject matter. For example, an additional prefilter or second prefilter (not shown) may be used prior to prefilter 110. The additional prefilter may remove large particles from the polluted air before it can enter prefilter 110. This way, the efficiency of IEF module 104 can be further enhanced.

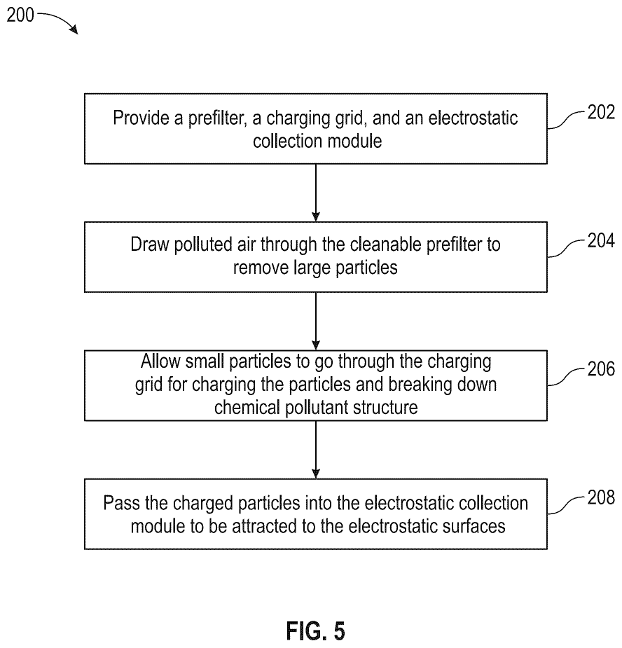

FIG. 5 illustrates a method 200 of removing particle and chemical pollutants, in accordance with one embodiment of the present subject matter. The order in which method 200 is described should not be construed as a limitation, and any number of the described method blocks can be combined in any order to implement method 200 or alternate methods. Additionally, individual blocks may be deleted from method 200 without departing from the spirit and scope of the invention described herein. For ease of explanation, in the embodiments described below, method 200 may be implemented using the above-described IEF module 104.

Method 200 starts at step 202. At step 202, a prefilter 110, a charging grid 112, and an electrostatic collection module 114 are provided within IEF module 104. At step 204, prefilter 110 draws polluted air to remove large particles. The remaining smaller particles are made to go through charging grid 112. At step 206, an electric field charges the particles and begins breakdown of chemical pollutant structure at charging grid 112. Subsequently, the charged particles are made to pass into electrostatic collection module 114, as shown at step 208. The charged particles are made to get attracted to the electrostatic surfaces resulting in very high removal of particles (over 95%), and destruction of germs and chemical pollutants.

The ionic electric field (IEF) technology can be used in a variety of applications, such as for laser fume and dust extraction. Further, the IEF technology can be used in 3D printing air purification. Furthermore, the IEF technology can be used in medical device manufacturing, medical/hospital facility air purification, and dental facility air purification.

Further, the IEF technology can be used in commercial cannabis/marijuana processing, growing, extraction, germination, flowering, and distribution. The IEF technology can be used in food industry, grocery industry, grocery stores, and food preservation containers to include food preservation involved with space missions. Additionally, the IEF technology can be used in wine manufacturing, storage industries, restaurant air purification, pizza oven air purification, etc. Optionally, the IEF technology can be used for retrofitting any air purifier or extractor's filter to eliminate disposable filters. The IEF technology can be used to retrofit any machine's filter to eliminate pollutants and possibly disposable filters any inline filtration between any machine and extractor to save main air purifier filters. The IEF technology can be used in boat/marine applications, cruise ship, cargo transport, cabin air purification, etc. The IEF technology can be used in military facility and field operation air purification applications. Further, the IEF technology can be used in silicon chip or other chip manufacturing, to include graphene. Furthermore, the IEF technology can be used in printing of various types, to remove particles and fumes.

The presently disclosed filtration system provides several advantages over the prior art. The presently disclosed filtration system uses ionic electric field (IEF) technology to filter the particles and chemical pollutants instead of the traditional bag filter in the inline filter box. The IEF filtration system has a cleanable electrostatic collection module, which attracts the electrically charged particles resulting in very high removal of particles (over 95%), and destruction of germs and chemical pollutants. The electrostatic collection module eliminates the need for the traditional bag filters in common inline filter units. Further, the electrostatic collection module reduces the cost of the filter for the operator and greatly increases the life of the filter in the extractor filter.

A person skilled in the art appreciates that the filtration system can come in a variety of shapes and sizes depending on the need and comfort of the user. Further, many changes in the design and placement of components may take place without deviating from the scope of the presently disclosed filtration system.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A filtration system, comprising:
an enclosure; and
an ionic electric field (IEF) module positioned within said enclosure, said IEF module comprising:
a prefilter configured to receive a flow of polluted air and remove large particles from said polluted air;
a charging grid positioned downstream of said prefilter, wherein said charging grid is configured to receive remaining smaller particles and apply an electric field to charge said smaller particles; and
an electrostatic collection module positioned downstream of said charging grid, wherein said electrostatic collection module is configured to attract and remove said charged particles from said polluted air to produce a flow of cleaned air.

2. The filtration system of claim 1, wherein said prefilter is cleanable and reusable.

3. The filtration system of claim 1, wherein said electrostatic collection module is cleanable and reusable.

4. The filtration system of claim 1, wherein said charging grid is configured to apply a high-voltage negative charge to break down a chemical structure of pollutants in said smaller particles.

5. The filtration system of claim 4, wherein said electrostatic collection module is configured to utilize a Two-Pole Active (TPA) technology to generate a high-voltage electric field.

6. The filtration system of claim 5, wherein said high-voltage electric field generates a coulomb force to destroy a molecular structure of airborne microorganisms in the air.

7. The filtration system of claim 1, further comprising a second prefilter positioned upstream of said prefilter, wherein said second prefilter is configured to remove large particles from said flow of polluted air.

8. The filtration system of claim 1, wherein said cleaned air exits said electrostatic collection module and enters a main extractor system.

9. The filtration system of claim 1, wherein said filtration system is adapted for use in applications selected from a group consisting of laser fume extraction, three-dimensional (3D) printing air purification, medical device manufacturing, hospital facility air purification, dental facility air purification, commercial cannabis processing, food industry air purification, wine manufacturing, restaurant air purification, and marine cabin air purification.

10. A filtration system, comprising:
an enclosure; and
an ionic electric field (IEF) module positioned within said enclosure, wherein said IEF module is configured to replace a bag filter in an inline filter box of said enclosure for removing particle and chemical pollutants during laser and three-dimensional (3D) printing fume and dust extraction, said IEF module comprising:
a prefilter configured to receive a flow of polluted air and remove large particles from said polluted air;
a charging grid positioned downstream of said prefilter, wherein said charging grid is configured to receive remaining smaller particles from said prefilter and apply a high-voltage negative charge to break down a chemical structure of pollutants in said smaller particles; and
an electrostatic collection module positioned downstream of said charging grid, wherein said electrostatic collection module is configured to attract and remove said charged particles from said polluted air to produce a flow of cleaned air.

11. The filtration system of claim 10, wherein said prefilter is cleanable and reusable.

12. The filtration system of claim 10, wherein said electrostatic collection module is cleanable and reusable.

13. The filtration system of claim 10, wherein said electrostatic collection module is configured to utilize a Two-Pole Active (TPA) technology to generate a high-voltage electric field.

14. The filtration system of claim 13, wherein said high-voltage electric field generates a coulomb force to destroy a molecular structure of airborne microorganisms in the air.

15. The filtration system of claim 10, further comprising a second prefilter arranged upstream of said prefilter, wherein said second prefilter is configured to remove large particles from said flow of polluted air.

16. The filtration system of claim 10, wherein said cleaned air exits said electrostatic collection module and enters a main extractor system.

17. The filtration system of claim 10, wherein said filtration system is adapted for use in applications selected from a group consisting of laser fume extraction, three-dimensional (3D) printing air purification, medical device manufacturing, hospital facility air purification, dental facility air purification, commercial cannabis processing, food industry air purification, wine manufacturing, restaurant air purification, and marine cabin air purification.

18. A method of removing particle and chemical pollutants from polluted air, said method comprising the steps of:
providing an enclosure;
providing an ionic electric field (IEF) module within said enclosure, said IEF module comprising a prefilter, a charging grid, and an electrostatic collection module;
drawing a flow of polluted air through said prefilter to remove large particles and producing filtered air containing smaller particles;
passing said filtered air through said charging grid to apply a high-voltage negative charge to said smaller particles, thereby producing charged particles and initiating a breakdown of chemical pollutant structures; and
directing said charged particles through said electrostatic collection module to attract and remove said charged particles from the air to produce a flow of cleaned air.

19. The method of claim 18, further comprising generating a coulomb force with said electrostatic collection module to destroy a molecular structure of airborne microorganisms in said filtered air.

20. The method of claim 18, further comprising cleaning said prefilter and said electrostatic collection module for reuse.
